(19) United States
(12) Patent Application Publication
(10) Pub. No.: US 2012/0032835 A1
(43) Pub. Date: Feb. 9, 2012

(54) THREE-DIMENSIONAL TARGET TRACKING

(76) Inventors: Silvia Mazzei, Roma (IT); Ausra Vargonaite, Rome (IT)

(21) Appl. No.: 13/206,036

(22) Filed: Aug. 9, 2011

(30) Foreign Application Priority Data
Aug. 9, 2010 (IT) TO2010A 000685

(51) Int. Cl. G01S 13/48

(52) U.S. Cl. 342/123

(57) ABSTRACT

The invention relates to a three-dimensional target tracking method comprising acquiring a first track generated by a first target location system having a first coverage area, said first track comprising a first position of a first target at a given time in a first relative reference system of the first target location system; acquiring a second track generated by a second target location system having a second coverage area partially overlapping the first coverage area in a coverage region shared by the two target location systems, said second track comprising a second position of a second target at the given time in a second relative reference system of the second target location system; and carrying out a correlation test and, if a same height is determined for the first and second targets, detecting that the first and second targets represent a same single target present in the shared coverage region.

### CROSS-REFERENCE TO RELATED APPLICATIONS

This application claims priority under 35 U.S.C. §119 to Italian Patent Application No. TO2010A 000685, filed Aug. 9, 2010, the entirety of which is hereby incorporated by reference.

### FIELD OF THE INVENTION

The present invention relates to three-dimensional target tracking. In particular, the present invention allows a three-dimensional track of a target to be generated on the basis of two-dimensional and/or three-dimensional tracks generated by target location systems.

### BACKGROUND OF THE INVENTION

As known, target location system means a system/apparatus/device designed to locate one or more targets.

In particular, hereinafter, the expression “target location system” is intended to mean a system configured to generate and provide tracking data which indicate position and speed of a target, and which will be called “target tracks” hereinafter for description simplicity. Target tracks may comprise two-dimensional (2D) or three-dimensional (3D) positions and speeds.

In detail, a two-dimensional (2D) position and a two-dimensional (2D) speed of a two-dimensional target track (2D) may be expressed in:
polar (or slant) coordinates, i.e. in terms of range ρ and azimuth θ, and range speed component V_{ρ} and azimuth speed component V_{θ}, respectively;
bearing coordinates, i.e. in terms of azimuth θ and elevation φ, and azimuth speed component V_{θ} and elevation speed component V_{φ}, respectively;
geographic coordinates, i.e. in terms of latitude lat and longitude long, and speed components with respect to latitude Vₗₐₜ and longitude V_{long}, respectively; and
Cartesian coordinates, i.e. in terms of coordinates (x,y) and speed, components (Vₓ,V_{y}) with respect to a Cartesian plane tangent to the surface of the Earth, respectively.

Furthermore, a three-dimensional position (3D) and a three-dimensional speed (3D) of a three-dimensional target track (3D) may be expressed in:
spherical coordinates, i.e. in terms of range ρ, azimuth θ and elevation φ, and range speed component V_{ρ}, azimuth speed component V_{θ} and elevation speed component V_{φ}, respectively;
geographic coordinates, i.e. in terms of latitude lat, longitude long and altitude alt, and speed components with respect to latitude Vₗₐₜ, longitude V_{long} and altitude Vₐₗₜ, respectively; and
Cartesian coordinates, i.e. in terms of coordinates (x,y) and speed components (Vₓ,V_{y},V_{z}) with respect to a given Cartesian three-dimensional reference system, respectively.

Examples of target location systems are:
radar systems, such as
   the so-called Primary Surveillance Radars (PSRs), which generally provide two-dimensional (2D) target tracks expressed in polar (or slant) coordinates, and
   the so-called Secondary Surveillance Radars (SSRs), which generally provide three-dimensional (3D) target tracks expressed in spherical coordinates;
radio direction finding systems, which generally provide two-dimensional (2D) target tracks expressed in bearing coordinates; and
satellite location terminals which, on the basis of signals received from a Global Navigation Satellite System (GNSS), such as for example GPS system, Galileo system or GLONASS system, and when enabled, also from a Satellite Based Augmentation System (SBAS), such as for example WAAS system, EGNOS system or MASAS system, determine two-dimensional (2D) or three-dimensional (3D) tracks of the targets on board which they are installed, said tracks being generally expressed in geographic or Cartesian coordinates.

Hereinafter, for description simplicity, the two-dimensional position/speed/tracks will be called 2D positions/speed/tracks, while the three-dimensional position/speed/tracks will be called 3D position/speed/tracks.

Similarly, hereinafter, again for description simplicity, target location systems which provide (i.e. generate) 2D tracks will be called 2D location systems, while target location systems which provide (i.e. generate) 3D tracks will be called 3D location systems.

2D and/or 3D location systems are currently used within the scope of maritime, air and land surveillance, e.g. for coast surveillance or in airports.

For example, a known air surveillance system which uses two 2D radars is described in German patent application DE 41 23 898 A1.

In particular, DE 41 23 898 A1 describes a 3D radar system which comprises two 2D radars separated by a known distance on a horizontal plane which transmit fan-shaped beams by turning in synchronized manner in opposite directions. Said 3D radar system calculates the height of a flying object by means of triangulation using the range measurements relative to the flying object provided by two 2D radars and the distances between said 2D radars and the intersection point of the beams. When the target is out of the vertical plane of symmetry of the 3D radar system, DE 41 23 898 A1 suggests to determine a relation between the angular positions of the beams as a function of the direction of flight and of the speed of the flying object.

As described in DE 41 23 898 A1, in order to determine a 3D track of a flying object, it is absolutely necessary to use two 2D radars configured to transmit fan-shaped beams by turning in synchronized manner in opposite directions.

### SUMMARY OF THE INVENTION

Currently, target location systems which may operate in mutually even very different manners are used in the scope of maritime, air and land surveillance, and for this reason the Applicant felt the need to develop a three-dimensional target tracking method which did not require the need to impose specific operating constraints to the target location systems used, unlike, for example, the 3D radar system described in DE 41 23 898 A1, in which the two 2D radars must necessarily transmit fan-shaped beams turning in synchronized manner in opposite directions.

Furthermore, target location systems which may provide 2D and/or 3D target tracks expressed in different formats, e.g. slant, bearing, geographic, spherical or Cartesian coordinates, are currently used in the scope of maritime, air and land surveillance, and for this reason the Applicant felt the need to develop said three-dimensional target tracking method so that said method allows a 3D target track to be generated on the basis of 2D and/or 3D tracks expressed in any format.

Therefore, it is an object of the present invention to provide a method for generating a 3D target track on the basis of 2D and/or 3D tracks expressed in any format and generated by track location systems operating in any manner.

The aforesaid object is reached by the present invention in that it relates to a three-dimensional target tracking method and to a system, a processor and a software program product configured to implement said three-dimensional target tracking method as defined in the appended claims.

In particular, the three-dimensional target tracking method according to the present invention comprises:
acquiring a first track generated by a first target location system having a first coverage area, said first track comprising a first position of a first target at a given time in a first relative reference system of the first target location system;
acquiring a second track generated by a second target location system having a second coverage area partially overlapping the first coverage area in a coverage region shared by the two target location systems, said second track comprising a second position of a second target at the given time in a second relative reference system of the second target location system;
carrying out a correlation test which includes
   checking whether a same height is determined for the first target and the second target in a given three-dimensional reference system on the basis of the first position and the second position, and
   if a same height is determined for the first target and the second target in the given three-dimensional reference system, detecting that the first target and the second target represent a same single target present in the shared coverage region; and,
if the first target and the second target represent the same single target present in the shared coverage region, generating a three-dimensional track which comprises a three-dimensional position of said same single target at the given time in the given three-dimensional reference system, said three-dimensional position comprising the same height determined for the first target and the second target in the given three-dimensional reference system.

Preferably, the correlation test is carried out if a given distance between the two target location systems satisfies a given relation with a given maximum linear measuring error of the two target location systems. Conveniently, the correlation test is carried out if the given distance is higher than, or equal to, said maximum linear measuring error. Even more conveniently, the maximum linear measuring error equals the greater of a first maximum linear measuring error of the first target location system and a second maximum linear measuring error of the second target location system.

Preferably, at least the first acquired track is expressed in slant or bearing or spherical coordinates.

Conveniently, if also the second acquired track is expressed in slant or bearing or spherical coordinates, the correlation test includes:
determining a first direction identified on a reference plane of the given three-dimensional reference system by the first position and by a position of the first target location system;
determining a second direction identified on the reference plane of the given three-dimensional reference system by the second position and by a position of the second target location system;
checking whether the first direction and the second direction satisfy a first given condition;
if the first direction and the second direction satisfy the first given condition, checking whether the first position, the second position and a given distance between the two target location systems satisfy a triangle-inequality-related condition; and,
if the first position, the second position and the given distance satisfy the triangle-inequality-related condition, checking whether a same height is determined for the first target and the second target in the given three-dimensional reference system.

Conveniently, the first direction and the second direction satisfy the first given condition if they either intersect or coincide.

Conveniently, the first position, the second position and the given distance satisfy the triangle-inequality-related condition if a sum of a first distance of the first target from the first target location system in the first relative reference system and of a second distance of the second target from the second target location system in the second relative reference system is higher than, or equal to, said given distance decreased and increased by a given measuring error of the two target location systems. Even more conveniently, the given measuring error of the two target location systems is equal to a sum of a first range measuring error of the first target location system and of a second range measuring error of the second target location system.

Conveniently, if the second acquired track is expressed in geographic or Cartesian coordinates, the correlation test includes:
determining a first direction identified on a reference plane of the given three-dimensional reference system by the first position and by a position of the first target location system;
determining a third position of the second target on the reference plane of the given three-dimensional reference system on the basis of the second position and of an origin position of the second relative reference system in the given three-dimensional reference system;
checking whether the first direction and the third position satisfy a second given condition; and,
if the first direction and the third position satisfy the second given condition, checking whether a same height is determined for the first target and the second target in the given three-dimensional reference system.

Conveniently, the first direction and the third position satisfy the second given condition if said first direction passes through the third position.

Preferably, the first acquired track also comprises a first speed of the first target at the given time in the first relative reference system, the second acquired track also comprises a second speed of the second target at the given time in the second relative reference system, and generating a three-dimensional track comprises calculating a three-dimensional speed of said same single target at the given time in the given three-dimensional reference system on the basis of the first position, the second position, the first speed, the second speed and the same height determined for the first target and the second target in the given three-dimensional reference system, said three-dimensional track also comprising the calculated three-dimensional speed.

Conveniently, the three-dimensional speed is also calculated the basis of:
a first quantity, which is related to the same height determined for the first target and the second target in the given three-dimensional reference system and indicates a first height of the first target at the given time in the first relative reference system; and
a second quantity, which is related to the same height determined for the first target and the second target in the given three-dimensional system and indicates a second height of the second target at the given time in the second relative reference system.

### BRIEF DESCRIPTION OF THE DRAWINGS

For a better understanding of the present invention, some preferred embodiments thereof will now be illustrated only by way of non-limitative example, and with reference to the accompanying drawings (not in scale), in which:

FIG. 1 schematically illustrates a three-dimensional target tracking system according to the present invention;

FIG. 2 schematically shows measuring errors of a primary surveillance radar;

FIG. 3 schematically shows two primary surveillance radars and respective coverage areas;

FIG. 4 schematically shows an absolute reference system used in a first operative scenario for carrying out a correlation test of two two-dimensional tracks according to a preferred embodiment of the present invention;

FIG. 5 schematically shows a Cartesian reference plane used in a second operative scenario for carrying out a correlation test of two two-dimensional tracks according to a further embodiment of the present invention; and

FIG. 6 schematically shows a target location system positioned on the surface of the Earth which locates and tracks a target positioned at a given distance from the surface of the Earth.

### DETAILED DESCRIPTION OF THE INVENTION

The present invention will now be described in detail with reference to the accompanying drawings to allow a person skilled in the art to provide and use the same. Various changes to the described embodiments will be immediately apparent to people skilled in the art, and the described general principles may be applied to other embodiments and applications without therefore departing from the scope of protection of the present invention, as defined in the appended claims.

Therefore, the present invention must not be considered limited to the described and illustrated embodiments but instead confers the broadest scope of protection, in accordance with the principles and features described and claimed herein.

Furthermore, the present invention is actuated by means of a software program product comprising code portions adapted to implement, when the software program product is loaded in the memory of an electronic processor and executed by said electronic processor, the target tracking method described below.

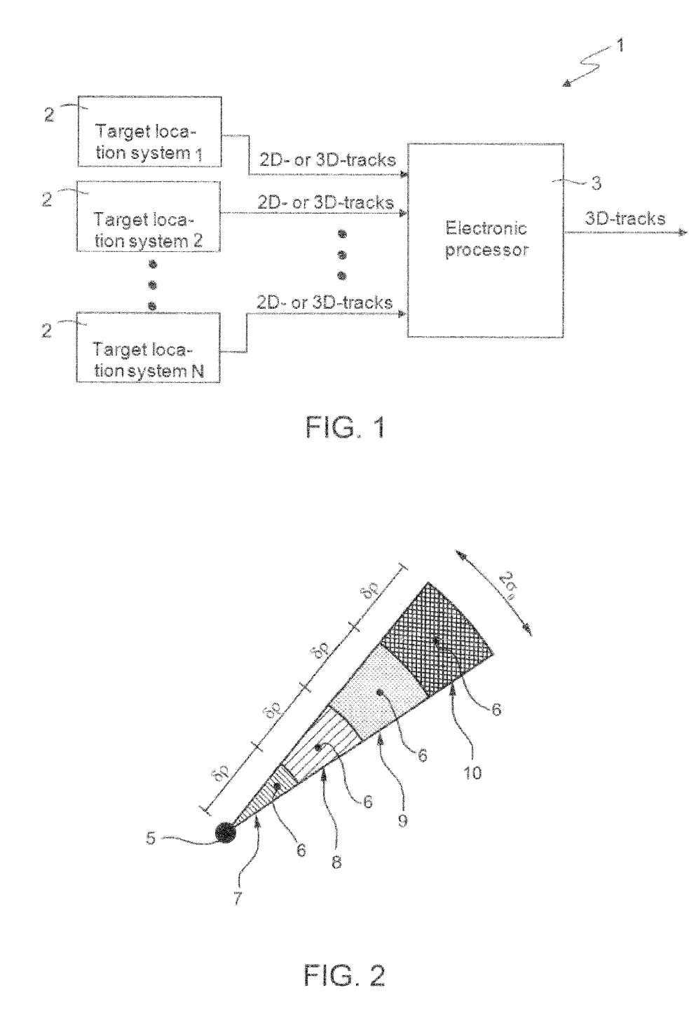

FIG. 1 shows a block chart representing a three-dimensional target tracking system 1 according to the present invention.

In particular, as shown in FIG. 1, the three-dimensional target tracking system 1 comprises N target location systems 2, where N is an integer number higher than, or equal to, two, i.e. N≧2.

In particular, each track location system 2 is configured to generate respective 2D or 3D target tracks.

Furthermore, again as shown in FIG. 1, the three-dimensional target tracking system 1 also comprises an electronic processor 3, e.g. a computer, which is coupled to N target location systems 2 to acquire therefrom the respective generated 2D or 3D tracks and is programmed to generate 3D target tracks on the basis of the acquired tracks in accordance with the three-dimensional track tracking method according to the present invention.

The N target location systems 2 may conveniently comprise:
one or more radar system(s), e.g. one or more PSR(s) and/or one or more SSR(s); and/or
one or more radio direction finding system(s); and/or
one or more satellite location terminal(s).

Therefore, the 2D positions and 2D speeds contained in the 2D tracks acquired by the electronic processor 3 may be expressed in slant coordinates (ρ,θ; V_{ρ},V_{θ}) and/or bearing coordinates (θ,φ; V_{θ},V_{φ}) and/or geographic coordinates (lat,long; Vₗₐₜ,V_{long}) and/or Cartesian coordinates (x,y; Vₓ,V_{y}), and the 3D positions and 3D speeds contained in the 3D tracks acquired by the electronic processor 3 may be expressed in spherical coordinates (ρ,θ,φ; V_{ρ},V_{θ},V_{φ}) and/or geographic coordinates (lat,long,alt; Vₗₐₜ,V_{long},Vₐₗₜ) and/or Cartesian coordinates (x,y,z; Vₓ,V_{y},V_{z}).

Preferably, the electronic processor 3 in use acquires at least one, track generated by a target location system 2 which either directly measures azimuth θ of the targets, or which provides independent measurements which allow azimuth θ of the targets to be determined. In other words, the electronic processor 3, in use, preferably acquires at least one track, which comprises a position coordinate related to the azimuth θ or which comprises at least two independent position coordinates which allow azimuth θ to be determined.

In particular, the electronic processor 3, in use, may conveniently acquire at least one track expressed in slant or bearing or spherical coordinates.

According to the above description and to FIG. 1, the three-dimensional target tracking system 1 has an architecture in which the 3D tracking occurs on calculation centre level.

Hereinafter, for description simplicity and without loosing in generality, the method according to the present invention will be described with reference to only two 2D and/or 3D location systems (i.e. with N=2). It remains understood, however, that the method according to present invention may be applied to 2D and/or 3D tracks generated by any number N of 2D and/or 3D location systems, with N≧2.

Therefore, in order to describe the present invention in detail, there are considered a first 2D or 3D location system, (hereinafter called system A for description simplicity) and a second 2D or 3D location system (hereinafter called system B for description simplicity again) which are positioned so as to have a shared coverage region, in which one or more targets are detected, system A generating a respective first 2D or 3D track and system B generating a respective second 2D or 3D track. In accordance with the three-dimensional target tracking method according to the present invention, a correlation test based on a calculation of the height of the targets is carried out on the first and second tracks to check whether and which tracks belong to same real targets while calculating at the same time the respective heights in a single three-dimensional reference system.

In other words, on the basis of kinematic data generated by at least two target location systems having a shared coverage region, the 2D and/or 3D tracks belonging to a same target present in said shared coverage region can be correlated according to the present invention so as to calculate a respective height in a single three-dimensional reference system, and preferably also the height component of the respective speed.

In particular, the three-dimensional tracking method according to the present invention allows a fused 3D track to be determined in which kinematics, i.e. position and speed, of a target present in the coverage region shared by at least two 2D location systems is complemented by the third dimension and calculated taking into account kinematics of the 2D tracks generated by said 2D location systems, thereby allowing the correlation, prediction and identification of the category, i.e. surface or air, of the fused 3D track to be improved. Therefore, the three-dimensional target tracking method according to the present invention allows a target with 3D kinematics to be identified as result of a fusion between two or more 2D tracks expressed in slant and/or bearing and/or geographic and/or Cartesian coordinates.

Furthermore, the three-dimensional target tracking method according to the present invention allows a single fused 3D track to be determined on the basis of two or more 3D tracks expressed in spherical and/or geographical and/or Cartesian coordinates.

Therefore, resuming the detailed description of the present invention, systems A and B may be either both positioned on the ground, also at different heights, or one of said systems may be installed on moving means with a motion considered inertial, except for appropriate corrections (i.e. which can be approximated to a uniform rectilinear motion in the interval of time significant for 2D or 3D measurement, e.g. in the case of a radar, the scanning period T, typically from 1 to 10 seconds, at which the apparatus monitors and sends data), e.g. a ship or a satellite, while the other is positioned on the ground, or both said systems A and B can be installed on moving means, e.g. ships or satellites. Indeed, the application of the three-dimensional target tracking method according to the invention is possible also when one or more target location systems are installed on respective moving means because, if the kinematics of the moving means are known, the kinematics of the 2D and/or 3D tracks may be corrected on the basis of pitch, roll and yaw movements of the moving means.

In the case of means the motion of which is not completely expectable, such as a ship, the approximating inertia system remarks apply to the case of motion of robotized means (satellite or means on pre-set trajectories with known algorithms) the trajectory of which is perfectly known in time and space in each instant, i.e. with known motion equations.

Therefore, for means with variable motion, it is always possible to make the due corrections to the kinematics of a target seen from a target location system installed on said means.

Systems A and B are preferably positioned so that their respective distance D is equal to, or higher than, a maximum linear measuring error Err_{MAX} of said systems, i.e. using a mathematical formalism, the distance D between the systems A and B satisfies the following mathematical constrain:

Err_{MAX}≦D. (1)

In particular, if Err_{A-MAX} is the maximum linear measuring error of system A and Err_{B-MAX} is the maximum linear measuring error of system B, then Err_{MAX} is equal to the greater of Err_{A-MAX} and Err_{B-MAX}, i.e. using a mathematical formalism:

Err_{MAX}=max[Err_{A-MAX},Err_{B-MAX}]

The measuring error shape of a measuring apparatus is known to depend on the nature of measured datum. For example, in the case of a PSR, the manner of “seeing” space is not isomorphous but polarly distorted instead. In other words, a PSR generally has, for range measurements, a constant range measuring error δρ and, for azimuth measurements, a constant azimuth measuring error 2σ_{θ} which, however, give rise to a total measuring error which, for a target “seen” by the PSR under the same azimuth angle equal to the measuring error in azimuth 2σ_{θ}, varies according to the distance of said target from the PSR.

In particular, in a PSR, the total measuring error is greater in amplitude the farther the target to be located is from the centre of the PSR.

For a better understanding of the maximum linear measuring error of a PSR, FIG. 2 schematically shows how the total measuring error of a PSR 5, having a constant by range measuring error and a constant azimuth 2σ_{θ} measuring error, varies according to the distance from the PSR 5 of a target 6 “seen” by PSR 5 on a reference plane under the same azimuth angle equal to the azimuth measuring error 2σ_{θ}, i.e. “seen” by PSR 5 on the reference plane in a circular section identified by an angle which is equal to the azimuth measuring error 2σ_{θ} and which has the PSR 5 as vertex, said reference plane being perpendicular to the rotation axis (not shown in FIG. 2) of the PSR 5.

In particular, FIG. 2 shows, for each distance of the target 6 from the PSR 5, a respective total measuring error which is represented by a respective portion of said circular sector indicated with reference numerals 7, 8, 9 and 10, respectively.

Therefore, if the system A is a PSR which has an azimuth measuring error 2σ_{θA} and a maximum coverage C_{A-MAX}, then the maximum linear measuring error Err_{A-MAX} of the PSR A is equal to the angular error rectified at the maximum coverage distance C_{A-MAX}, i.e. is equal to 2σ_{θA}C_{A-MAX}. Similarly, if the system B is a PSR which has an azimuth measuring error 2σ_{θB} and a maximum coverage C_{B-MAX}, then the maximum linear measuring error Err_{B-MAX} of the PSR B is equal to the angular error rectified at the maximum coverage distance C_{B-MAX}, i.e. is equal to 2σ_{θB}C_{B-MAX}.

Therefore, on the basis of the previous description and assuming that

Err_{MAX}=2\tilde{σ}_{θ}\tilde{C}_{MAX}=max[Err_{A-MAX},Err_{B-MAX}],

the PSRs A and B are preferably positioned so that their reciprocal distance D satisfies the mathematical constraint (1) that, in the assumption of two PRSs, becomes:

2\tilde{σ}_{θ}\tilde{C}_{MAX}≦D, (2a)

where 2\tilde{σ}_{θ} denotes the azimuth measuring error of the PSR having the highest maximum linear measuring error between the PSRs A and B and \tilde{C}_{MAX} denotes the maximum coverage of the PSR having the highest maximum linear measuring error between the PSRs A and B.

For example, if \tilde{C}_{MAX} is equal to 100 Km and 2\tilde{σ}_{θ} is equal to 0.005 rad, i.e. approximately 0.3°, then the distance D between the PSRs A and B is equal to, or greater than, 1 Km.

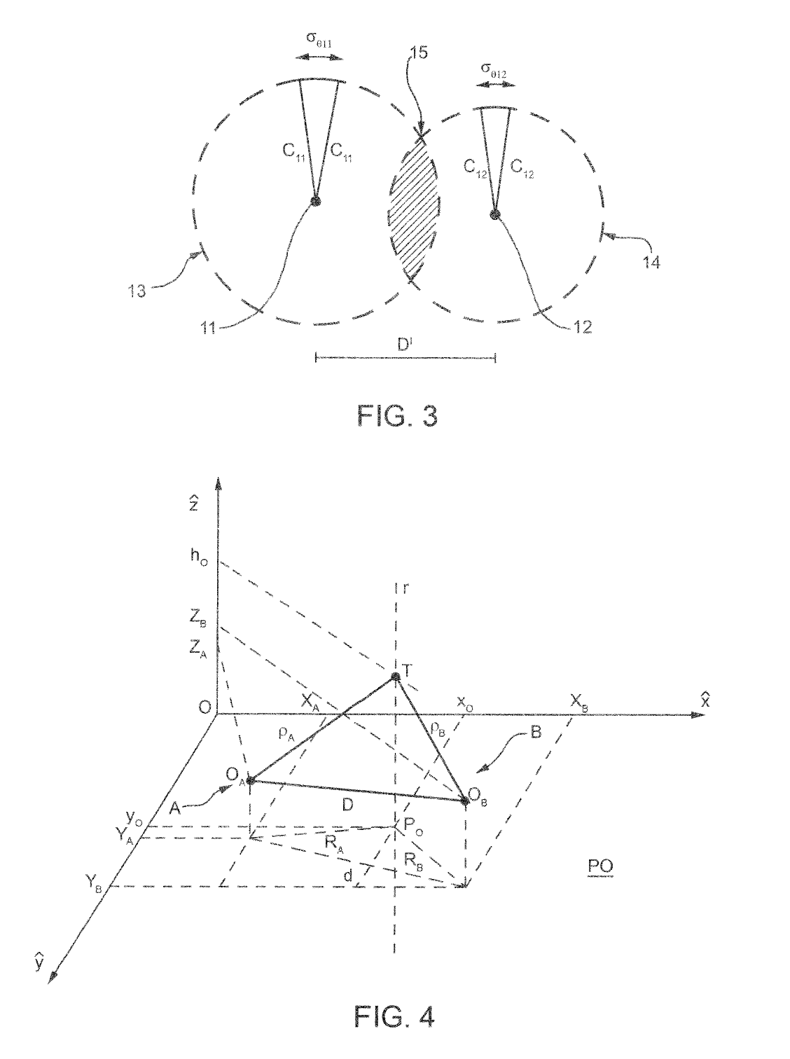

With this regard, FIG. 3 schematically shows on a reference plane a first PSR 11 having a first azimuth measuring error 2σ_{θ11} and a first maximum coverage C₁₁ and a second PSR 12 having a second azimuth measuring error 2σ_{θ12} and a second maximum coverage C₁₂, which are distanced by a distance D such as to satisfy the mathematical constraint (2a), said reference plane being perpendicular to the rotation axes (not shown in FIG. 3) of the first PSR 11 and of the second PSR 12 (said rotation axes, in the example shown in FIG. 3, being assumed parallel to each other). Furthermore, in FIG. 3, D′ indicates the projection on said reference plane of the distance D between the first PSR 11 and the second PSR 12.

In particular, FIG. 3 shows a first circle 13 which has as centre the first PSR 11 and as radius the first maximum coverage C₁₁ and which thus represents the coverage area of the first PSR 11 on said reference plane, and a second circle 14 which has the second PSR 12 as a centre and the second maximum coverage C₁₂ as the radius, and which thus represents the coverage area of the second PSR 12 on said reference plane. Furthermore, again as shown in FIG. 3, the first circle 13 and the second circle 14 have an intersection 15 which represents a shared coverage region of the PSRs 11 and 12 on said reference plane.

Radio direction finding systems instead display an azimuth measuring error 2σ_{θ} which is substantially equal to the elevation measuring error 2σ_{φ}. Therefore, if the system A is a radio direction finding system which has an azimuth/elevation measuring error 2σ_{A}^{θ/φ} and a maximum coverage C_{A-MAX}, then the maximum linear measuring error Err_{A-MAX} of said system A is equal to the angular error rectified at the maximum coverage distance C_{A-MAX}, i.e. is equal to 2σ_{A}^{θ/φ}C_{A-MAX}. Similarly, if the system B is a radio direction finding system which has an azimuth/elevation measuring error 2σ_{B}^{θ/φ} and a maximum coverage C_{B-MAX}, then the maximum linear measuring error Err_{B-MAX} of said system B is equal to the angular error rectified at the maximum coverage distance C_{B-MAX}, i.e. is equal to 2σ_{B}^{θ/φ}C_{B-MAX}.

Therefore, on the basis of the previous description and assuming that

Err_{MAX}=2\tilde{σ}^{θ/φ}\tilde{C}_{MAX}=max[Err_{A-MAX},Err_{B-MAX}],

the radio direction finding systems A and B are preferably positioned so that their reciprocal distance D satisfies the mathematical constraint (1) which, in the assumption of two radio direction finding systems, becomes:

2\tilde{σ}^{θ/φ}\tilde{C}_{MAX}≦D, (2b)

where 2\tilde{σ}^{θ/φ} denotes the azimuth/elevation measuring error of the radio direction finding system having the highest maximum linear measuring error radio between the direction finding systems A and B and \tilde{C}_{MAX} denotes the maximum coverage of the radio direction finding system having the highest maximum linear measuring error between the radio direction finding systems A and B.

Now, more in detail, mathematical constraint (1) depends on the capacity of the two systems A and B to distinguish two real objects. Therefore, systems A and B may be considered non-homocentric and not co-located if each system and a real object to be tracked can be “seen” in distinct positions by the other system.

In particular, mathematical constraint (1) takes into consideration the maximum linear measuring error Err_{MAX} so as to always ensure the possibility of carrying out a triangulation to determine a three-dimensional track of a target intercepted by the systems A and B, independently from the position of said target in the coverage region shared by said systems A and B.

In other words, if mathematical constraint (1) is satisfied, the target and the centers of the systems A and B form, within the limits of the maximum linear measuring error Err_{MAX}, the three distinguishable vertexes of a triangle.

If, instead, mathematical constraint (1) is not satisfied, the triangle degenerates into two parallel lines coinciding, within the limits of the maximum linear measuring error Err_{MAX}, and thus triangulation cannot be applied. In other words, if mathematical constraint (1) is not verified, a target is “seen” by the systems A and B under the same perspective.

Therefore, the correlation test is preferably carried out on the basis of the 2D and/or 3D tracks generated by the systems A and B only if the distance D between said systems A and B satisfies the mathematical constraint (1).

Hereinafter, in order to describe the present invention in detail, it is assumed that:
ST_{A}(ρ_{A},θ_{A}; V_{ρA},V_{θA}) is a first 2D slant track of a first target at time t in a first relative reference system of the system A generated by said system A; and
ST_{B}(ρ_{B},θ_{B}; V_{ρB},V_{θB}) is a second 2D slant track of a second target at time t (i.e. at the same time t of the first 2D slant track ST_{A}) in a second relative reference system of the system B generated by said system B.

Therefore, according to a preferred embodiment of the present invention, a test is carried out on tracks ST_{A} and ST_{B}, which are related to the same time t, to check whether they are related to a same single target. Furthermore, if the tracks ST_{A} and ST_{B} related to a same single target, the present invention allows the height of said target to be also calculated, while carrying out said correlation test.

In particular, the correlation test is verified by the tracks ST_{A} and ST_{B} if the following three conditions are satisfied:

1. the position vectors of the tracks ST_{A} and ST_{B}, if projected on a reference plane intersect (“intersection-related condition”);

2. the moduli of the position vectors of the tracks ST_{A} and ST_{B} and the distance D between the centers of the systems A and B satisfy a triangle-inequality-related condition, which, by using a mathematical formalism, is expressed by the following mathematical inequality:

∥ P̅_{A}|+| P̅_{B}∥≧D±δρ, (3)

where P̅_{A} is the position vector contained in the first 2D slant track ST_{A}, P̅_{B} is the position vector contained in the second 2D slant track ST_{B} and δρ=δρ_{A}+δρ_{B}, where δρ_{A} is the range measuring error of the system A and δρ_{B} is the range measuring error of the system B; and

3. the tracks ST_{A} and ST_{B} allow a same height to be determined for the first target and for the second target (“elevation-related condition”).

If all three above conditions are satisfied by the tracks ST_{A} and ST_{B}, then the correlation test is verified and, therefore, the tracks ST_{A} and ST_{B} relate to a same single target for which a 3D track MST(ρ,θ,φ; V_{ρ},V_{θ},V_{φ}) at the time t in an absolute reference system O is also generated.

FIG. 4 schematically shows an absolute reference system O used to carry out the correlation test of the tracks ST_{A} and ST_{B} according to said preferred embodiment of the present invention.

In particular, as shown in FIG. 4, the absolute reference system O is a system of three-dimensional Cartesian coordinates zxy.

In detail, FIG. 4 shows:
a point O_{A}, which represents the centre of the system A the coordinates (X_{A},Y_{A},Z_{A}) of which are known in the absolute reference system O;
a point O_{B}, which represents the centre of the system B the coordinates (X_{B},Y_{B},Z_{B}) of which are known in the absolute reference system O;
a line r which
   represents an intersection line between the rotation planes (not shown in FIG. 4) of the systems A and B passing through the position vectors of the tracks ST_{A} and ST_{B},
   identifies a direction vertical to the surface of the Earth, and
   passes through a point T which, if the tracks ST_{A} and ST_{B} satisfy the correlation test, represents the first target seen by system A and the second target seen by system B, is at a distance ρ_{A} (range of the first target in the first 2D slant track ST_{A}) from the system A and at a distance ρ_{B} (range of the second target in the second 2D slant track ST_{B}) from the system B and has coordinates (x₀,y₀,z₀) in the absolute reference system O; the axis \hat{z} of the absolute reference system O being parallel to line r;
a horizontal reference plane PO which is perpendicular to line r and thus to axis \hat{z} of the absolute reference system O as well, and which is conventionally positioned at z=0;
a point P₀ which has coordinates (x₀,y₀,0) in the absolute reference system O and which represents the intersection on the horizontal reference plane PO of the position vectors contained in tracks ST_{A} and ST_{B} projected on said horizontal reference plane PO; in FIG. 4, the projections on the horizontal reference plane PO of the position vectors contained in tracks ST_{A} and ST_{B} being indicated with R_{A} and R_{B}, respectively; and
the distance D between the systems A and B having a projection d on the horizontal reference plane PO.

Again with reference to the above description and to FIG. 4, with regards to the intersection-related condition, the 2D position vectors contained in tracks ST_{A} and ST_{B}, if projected on the horizontal reference plane PO must have a non-null intersection (i.e. P₀(x₀,y₀,0)) in order to be related to a same single target.

Therefore, in order to verify whether said intersection condition is satisfied or not, the method attempts to determine the Cartesian coordinates (x₀,y₀) of the intersection point P₀ of the position vectors of the tracks ST_{A} and ST_{B} projected on the horizontal reference plane PO by solving the following linear system of two equations in two unknowns:

$$\begin{matrix}\{ \begin{matrix}{x}_{0} - {X}_{A} = {m}_{A}^{O} ( {y}_{0} - {Y}_{A} ) \\ {x}_{0} - {X}_{B} = {m}_{B }^{O} ( {y}_{0} - {Y}_{B} )\end{matrix} \\ where & ( 4 ) \\ {m}_{A}^{O} = tg {θ}_{A} \\ and & ( 5 ) \\ {m}_{B}^{O} = tg {θ}_{B} . & ( 6 )\end{matrix}$$

Therefore, with the 2D slant coordinates (ρ_{A},θ_{A}) and thus the azimuth θ_{A} of the first target, the 2D slant coordinates (ρ_{B},θ_{B}) and thus the azimuth θ_{B} of the second target, the Cartesian coordinates (X_{A},Y_{A}) of the centre O_{A} of the system A in the absolute reference system O and the Cartesian coordinates (X_{B},Y_{B}) of the centre O_{B} of the system B in the absolute reference system O being known, determining the Cartesian coordinates (x₀,y₀) of the intersection point P₀ of the position vectors of tracks ST_{A} and ST_{B} projected on the horizontal reference plane PO is possible.

In particular, the intersection condition is verified, i.e. is satisfied by the 2D slant tracks ST_{A} and ST_{B}, if said Cartesian coordinates (x₀,y₀) of the intersection point P₀ can be calculated.

If even only one of the two 2D tracks is a 2D bearing track ST(θ,φ; V_{θ},V_{φ}), the Mathematical formulae (4), (5) and (6) are still valid, and thus may still be used to verify the intersection condition.

Furthermore, again according to said preferred embodiment of the present invention, if the intersection-related condition is satisfied by the tracks ST_{A} and ST_{B}, the method goes on to checking the triangle-inequality-related condition, i.e. checks whether the position vectors 2D contained in the tracks ST_{A} and ST_{B} and the distance D between the centers O_{A} and O_{B} of the systems A and B satisfy the triangle inequality (3) or not.

In particular, again with reference to that shown in FIG. 9, the triangle inequality (3) becomes:

ρ_{A}+ρ_{B}≧D±δρ, (7)

that is

ρ_{A}+ρ_{B}≧\sqrt{(X_{A}−X_{B})²+(Y_{A}−Y_{B})²+(Z_{A}−Z_{B})²}±δρ.

Therefore, with the range measurements ρ_{A} and ρ_{B} of the tracks ST_{A} and ST_{B}, the Cartesian coordinates (X_{A},Y_{A},Z_{A}) of the centre O_{A} of the system A in the absolute reference system O, the Cartesian coordinates (X_{B},Y_{B},Z_{B}) of the centre O_{B} of the system B in the absolute reference system O, the range measuring error δρ_{A} of the system A and the range measuring error δρ_{B} of the system B (noting again δρ=δρ_{A}+δρ_{B}) being known, checking whether the triangle-inequality-related condition is satisfied by the tracks ST_{A} and ST_{B} is possible, i.e. whether the moduli of the position vectors 2D contained in the tracks ST_{A} and ST_{B} and the distance D between the centers O_{A} and O_{B} of the systems A and B satisfy the triangle inequality.

If even only one of the two 2D tracks is a 2D bearing track ST(θ,φ; V_{θ},V_{φ}), checking whether the condition (7) is satisfied by the two tracks or not is still possible. Indeed, assuming for example that the system A is a radio direction finding system which thus supplies a 2D bearing track ST_{A}(θ_{A},φ_{A}; V_{θA},V_{φA}), it is possible to compute:

$${R}_{A} = \sqrt{{( {x}_{0} - {X}_{A} )}^{2} + {( {y}_{0} - {Y}_{A} )}^{2}} , \\ \frac{{R}_{A}}{cos {ϕ}_{A}} , and$$

$$δ {ρ}_{A} = \partial {( \frac{{R}_{A}}{cos ϕ} )}_{ϕ = {ϕ}_{A}} δ {ϕ}_{A} ,$$

where:
δφ_{A} is the elevation measuring error of the system A, and

$$\partial {( \frac{{R}_{A}}{cos ϕ} )}_{ϕ = {ϕ}_{A }}$$

indicates the first derivative of

$$\frac{{R}_{A}}{cos ϕ}$$

with respect to φ calculated for φ=φ_{A}.

Therefore, in the case of one or more 2D bearing track(s), checking whether condition (7) is satisfied or not is still possible.

Furthermore, again according to said preferred embodiment of the present invention, if the triangle-inequality-related condition is satisfied by the tracks ST_{A} and ST_{B}, then the method goes on to checking the elevation-related condition, i.e. checks whether the tracks ST_{A} and ST_{B} allow a same height to be determined for the first and second targets.

In particular, again with reference to that shown in FIG. 4, it results that:

(ρ_{A})²=(R_{A})²+(h_{O}−Z_{A})² (8)

and

(ρ_{B})²=(R_{B})²+(h_{O}−Z_{B})² (9)

where h_{O} denotes a possible same height of the first and second targets and where

(R_{A})²=(x_{θ}−X_{A})²+(y_{θ}−Y_{A})² (10)

and

(R_{B})²=(x_{θ}−X_{B})²+(y_{θ}−Y_{B})². (11)

Therefore, if the first and the second targets have the same height h_{O} and thus they are not two different targets but actually represent a same single target, thus solving the two second degree equations (8) and (9) having as unknown h_{O}, it must result that

h_{O}=Z_{A}±{square root over (((ρ_{A})²−(R_{A})²))}=Z_{B}±{square root over (((ρ_{B})²−(R_{B})²))}. (12)

Therefore, with the range measurements ρ_{A} and ρ_{B} of the tracks ST_{A} and ST_{B}, the Cartesian coordinates (X_{A},Y_{A},Z_{A}) of the centre O_{A} of the system A in the absolute reference system O, the Cartesian coordinates (X_{B},Y_{B},Z_{B}) of the centre O_{B} of the system B in the absolute reference system O and the Cartesian coordinates (x₀,y₀) of the point P₀ (calculated for checking the intersection-related condition) being known, it is possible to:
solve the second degree equation (8) with the aid of equation (10), and thus determine two first values of h_{O} for the first target seen by the system A and tracked in the track ST_{A}; and
solve the second degree equation (9) with the aid of the equation (11), and thus determine two second values of h_{O} for the second target seen by the system B and tracked in the track ST_{B}.

Threfore, if one of the two first values of h_{O} is equal to one of the two second values of h_{O}, it results that:
the elevation-related condition is satisfied by the tracks ST_{A} and ST_{B}, and thus the correlation test is also satisfied by the tracks ST_{A} and ST_{B}; and
the first and second targets represent a same single target which has the Cartesian coordinates (x₀,y₀,h₀) in the absolute reference system O, where h₀ assumes the same value determined for both targets, i.e. the value which satisfies equality (12).

Furthermore, on the basis of the height value h₀ which satisfies equality (12), the elevation angles φ_{A} and φ_{B} at which the same single target is seen in the first relative reference system of the system A and in the second relative reference system of the system B, respectively, can be calculated.

In particular, it results that:

$${ϕ}_{A} = arcsin ( \frac{{h}_{O} - {Z}_{A}}{{ρ}_{A }} ) , and$$

$${ϕ}_{B } = arcsin ( \frac{{h}_{O} - {Z}_{B}}{{ρ}_{B}} ) .$$

If even only one of the two 2D tracks is a 2D bearing track ST(θ,φ; V_{θ},V_{φ}), checking whether the elevation-related condition is satisfied by the two tracks or not is still possible. Indeed, assuming for example that the system A is a radio direction finding system and that it thus supplies a 2D bearing track ST_{A}(θ_{A},φ_{A}; V_{θA},V_{φA}), it is possible to compute:

R_{A}=\sqrt{(x_{θ}−X_{A})²+(y_{θ}−Y_{A})²} and

ρ_{A}=R_{A}/cos φ_{A}.

Therefore, in the case of one or more 2D bearing tracks, mathematical formulae (8), (9), (10), (11) and (12) may still be used to verify whether the elevation-related condition is satisfied or not. Furthermore, if said elevation-related condition is satisfied, the height h_{O} of the same single target seen by the two systems A and B is also determined.

If one of the two 2D tracks is instead a 2D track expressed in Cartesian or geographic coordinates, a correlation test may be carried out, which is different from that described above with regards to two slant and/or bearing tracks.

In particular, for example, assuming that the system A is a satellite location terminal which provides a 2D track of a first target expressed in geographic ST_{A}(lat,long; Vₗₐₜ,V_{long}) or Cartesian ST_{A}(x_{A},y_{A}; V_{xA}, V_{yA}) coordinates, the following may be calculated:
the coordinates (X_{A},Y_{A}) in the absolute reference system O of the origin of the geographic/Cartesian system used by the system A, i.e. the coordinates (X_{A},Y_{A}) in the absolute reference system O of the origin of the geographic/Cartesian reference system in relation to which the geographic (lat,long) or Cartesian (x_{A},y_{A}) position of the first target contained in the first 2D track ST_{A} provided by the satellite location terminal A is expressed; and
the Cartesian coordinates (x_{A}^{O},y_{A}^{O}) of the first target in the absolute reference system O on the basis of the coordinates (X_{A}, Y_{A}) and of the geographic/Cartesian coordinates (lat,long)/(x_{A},y_{A}), e.g. by using the following coordinate shift

x_{A}^{O}=lat+X_{A}O x_{A}^{O}=x_{A}+X_{A}, and

y_{A}^{O}=long+Y_{A}O y_{A}^{O}=y_{A}+Y_{A}.

In order to check the intersection-related condition, the method thus imposes that the Cartesian coordinates (x₀,y₀) of the point P₀ are equal to the Cartesian coordinates (x_{A}^{O},y_{A}^{O}) of the first target in the absolute reference system O.

Furthermore, in order to check whether the intersection-related condition is satisfied or not, in the assumption that, for example, system B is a PSR and that it thus provides the 2D track slant ST_{B}(ρ_{B},θ_{B}; V_{ρB},V_{θB}) of the second target, the method verifies whether the following mathematical relation is satisfied:

x_{A}^{O}−X_{B}=m_{B}^{O}(y_{A}^{O}−Y_{B}), (13)

where in m_{B}^{O}=tgθ_{B}.

Therefore, the intersection-related condition is verified, i.e. it is satisfied by the 2D tracks ST_{A} and ST_{B}, if the mathematical relation (13) is satisfied.

If the system B is a radio direction finding system, and thus the respective 2D track is a bearing track ST_{B}(θ_{B},φ_{B}; V_{θB}, V_{φB}), the mathematical relation (13) is still valid and thus can still be used for verifying the intersection-related condition.

In case of a 2D track expressed in Cartesian or geographic coordinates, the correlation test does not comprise the verification of the triangle-inequality-related condition, but directly includes the verification of the elevation-related condition, in particular a direct calculation of the height.

In detail, to find the height h_{O} if, for example, the system A is a satellite location terminal and the system B is a PSR, the following second degree equation is solved:

h_{O}=Z_{B}±{square root over ((ρ_{B})²−(R_{B})²))}, (14)

where (R_{B})²=(x_{A}^{O}−X_{B})²+(y_{A}^{O}−Y_{B})².

Instead, to find the height h_{O} if the system A is a satellite location terminal and the system B is a radio direction finding system, the equation (14) is solved again, in which ρ_{B} is calculated as:

$${ρ}_{B} = \frac{{R}_{B}}{cos {ϕ}_{B}} .$$

Two h₀ values are obtained by solving the equation (14): one corresponding to the plus sign and the other to the minus sign of the formula (14). In order to determine the height, running domain considerations is needed to choose the right physical solution. For example, the case of negative height may be excluded and the solution can be compared with the previous prediction data. Alternatively, if one of the two tracks is a 3D track, the height coordinate contained in said 3D track can be used to choose the correct height value h₀.

Furthermore, a first particular case when carrying out the correlation test occurs if systems A and B see the same target along a symmetry line, i.e. using a mathematical formalism, when Z_{A}=Z_{B} and ρ_{A}=ρ_{B}.

In said first particular case, R_{A}=R_{B} and h₀ may assume two values, one corresponding to the plus sign and other to the minus sign of formula (12).

In order to determine the height in said first particular case, running domain considerations is needed to choose the right physical solution. For example, the case of negative height may be excluded and the solution may be compared with the previous prediction data. Alternatively, if one of the two tracks is a 3D track, the height coordinate contained in said 3D track may be used to choose the correct height value h₀.

Furthermore, a second particular case when carrying out the correlation test occurs if systems A and B see a same target in a same direction, i.e. using a mathematical formalism, when m_{A}^{O}=m_{B}^{O}.

In particular, if during verification of the intersection-related condition, it is found that m_{A}^{O}=m_{B}^{O}, it is decided that said intersection-related condition is satisfied by the tracks ST_{A} and ST_{B}, and the method thus goes on to verifying the triangle-inequality-related condition without calculating the Cartesian coordinates (x₀,y₀) of the intersection point P₀.

If also the triangle-inequality-related condition is satisfied by the tracks ST_{A} and ST_{B}, then the method goes on to verifying the elevation-related condition by determining the elevation angles φ_{A} and φ_{B}, by means of a triangulation carried out on a reference plane zx perpendicular to the surface of the Earth and passing through the centre O_{A} of the system A and the centre O_{B} of the system B.

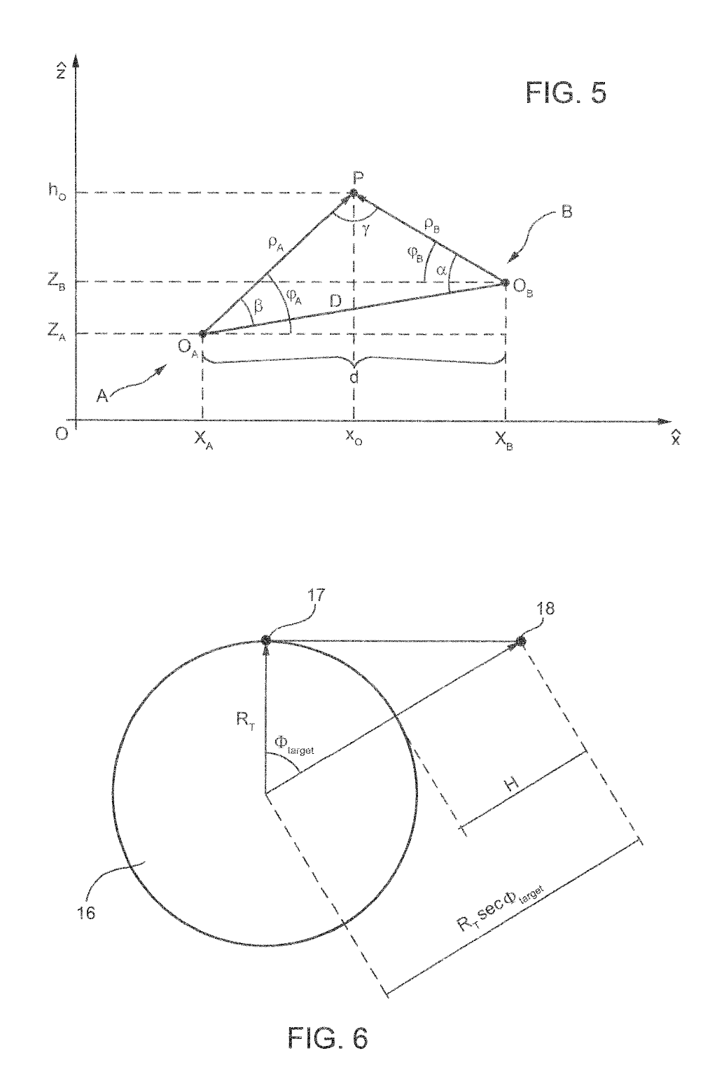

With this regard, FIG. 5 schematically shows a Cartesian reference plane zx used for verifying the height-related condition if m_{A}^{O}=m_{B}^{O} according to a further preferred embodiment of the present invention.

In particular, FIG. 5 shows:
a point O_{A}, which represents the centre of the system A the coordinates (X_{A},Z_{A}) of which are known on the Cartesian reference plane zx;
a point O_{A}, which represents the centre of the system B the coordinates (X_{B},Z_{B}) of which are known on the Cartesian reference plane zx;
a point P which, if tracks ST_{A} and ST_{B} satisfy the elevation-related condition, represents the first target seen by the system A and the second target seen by the system B, is at a distance ρ_{A} from the system A and at a distance ρ_{B} from the system B and has coordinates (x₀,h₀) on the Cartesian reference plane zx;
a distance D between the centre O_{A} of the system A and the centre O_{B} of the system B which has a projection d along direction \hat{x};
an angle α comprised between ρ_{B} and D;
an angle β comprised between ρ_{A} and D;
an angle γ comprised between ρ_{A} and ρ_{B};
an angle φ_{A}, which represents the elevation angle at which the point P is seen by the system A; and
an angle φ_{B} which represents the elevation angle at which the point P is seen by the system B.

In detail, with reference to FIG. 5 and applying the law of sines, it results that:

$$\frac{{ρ}_{A}}{sin α} = \frac{{ρ}_{B}}{sin β} = \frac{D}{sin γ} .$$

Furthermore, even applying Carnot's theorem (also known as law of cosenes), it results that:

D²=(ρ_{A})²+(ρ_{B})²−2ρ_{A}ρ_{B} cos γ.

Threfore, ρ_{A}, ρ_{B} and D being known, the angles α, β and γ are determined in accordance with the following mathematical formulae obtained on the basis of the two preceding equations obtained by applying the law of sines and Carnot's theorem:

$$γ = arccos ( \frac{{( {ρ}_{A} )}^{2} + {( {ρ}_{B} )}^{2} - {D}^{2}}{2 {ρ}_{A} {ρ}_{B}} ) , \\ α = arccos ( \frac{{ρ}_{A} sin γ}{D} ) and$$

$$β = 180 ° - α - γ .$$

Finally, since

φ_{A}−β=α−φ_{B} and

D cos(φ_{A}−β)=d,

the elevation angles φ_{A} and φ_{B} may be determined on the basis of the following formulae:

$${ϕ}_{B} = α - arccos ( \frac{d}{D} ) and$$

$${ϕ}_{A} = arccos ( \frac{d}{D} ) + β .$$

Therefore, again with reference to FIG. 5, in the case of m_{A}^{O}=m_{B}^{O}, the elevation-related condition is satisfied by the tracks ST_{A} and ST_{B}, and also the correlation test is thus satisfied by the tracks ST_{A} and ST_{B}, if it results that:

h_{O}=ρ_{A} sin φ_{A}+Z_{A}=ρ_{B} sin φ_{B}+Z_{B}.

Once the correlation test has finished, if it was verified that said correlation test is satisfied by the tracks ST_{A} and ST_{B}, a 3D speed is also preferably determined on the basis of the tracks ST_{A} and ST_{B} and, in particular, if the two tracks ST_{A} and ST_{B} are 2D tracks, a respective elevation component of the respective speed contained in the 2D track is determined for each of the two 2D tracks ST_{A} and ST_{B}.

In this regard, it is assumed that:
V̅_{A} is a first target speed vector (it is emphasized that, because the correlation test is satisfied by tracks ST_{A} and ST_{B}, the first target seen by the system A and tracked in the first 2D slant track ST_{A} is the same target, i.e. the second target, seen by the system B and tracked in the second 2D slant track ST_{B}) in spherical coordinates in the first relative reference system of the system A and comprises a first range component V_{ρA} which is contained in the first 2D slant track ST_{A}, a first azimuth component V_{θA} which is contained in the first 2D slant track ST_{A} and a first elevation component V_{φA} which is intended to be calculated;
V̅_{B} is the second target speed vector in spherical coordinates in the second reference system of the system B and comprises a second range component V_{ρB} which is contained in the second 2D slant track ST_{B}, a second azimuth component V_{θB} which is contained in the second 2D slant track ST_{B} and a second elevation component V_{φB} which is intended to be calculated;
V̅ is a third target speed vector in Cartesian coordinates in the absolute reference system O and comprises a first speed component Vₓ along direction \hat{x}, a second speed component V_{y} along direction ŷ and a third speed component V_{z} along direction \hat{z};
I_{A} is a first transformation matrix of spherical coordinates to Cartesian coordinates of the first speed vector V̅_{A} in a first position (ρ_{A},θ_{A},φ_{A}) which represents the position of the target in spherical coordinates in the first relative reference system of the system A, φ_{A} being the elevation angle in the first relative reference system of the system A calculated in the correlation test, θ_{A} being the azimuth angle contained in the first 2D slant track ST_{A}, and ρ_{A} being the range contained in the first 2D slant track ST_{A}; and
I_{B} is a second transformation matrix of spherical coordinates to Cartesian coordinates of the second speed vector V̅_{A} in a second position (ρ_{B},θ_{B},φ_{B}) which represents the position of the target in spherical coordinates in the second relative reference system of the system B, φ_{B} being the elevation angle in the second relative reference system of the system B calculated in the correlation test, θ_{B} being the azimuth angle contained in the second 2D slant track ST_{B}, and ρ_{B} being the range contained in the second 2D slant track ST_{B}.

Therefore, on the basis of the above description:
in the first position (ρ_{A},θ_{A},φ_{A}) V̅=I_{A} V̅_{A}; and
in the second position (ρ_{B},θ_{B},φ_{B}) V̅=I_{B} V̅_{B}.

Furthermore, because the first position (ρ_{A},θ_{A},φ_{A}) and the second position (ρ_{B},θ_{B},φ_{B}) coincide in the absolute reference system O within the measuring error limits, it must result that:

I_{A} V̅_{A}=I_{B} V̅_{B} (15)

Therefore, solving the three equation system represented by the matrix equation (13), the first elevation component V_{φA} and the second elevation component V_{φB} is determined.

Finally, once the first elevation component V_{φA} and the second elevation component V_{φB} have been determined, the third vector V̅ and, in particular, the respective third speed component V_{z} may be determined by applying equation V̅=I_{A} V̅_{A} or equation V̅=I_{B} V̅_{B}.

Preferably, the first relative reference system of the system A, the second relative reference system of the system B and the absolute reference system O have the same orientation with the respective vertical axis to the respective zenith and axis y oriented to the North.

In particular, the first relative reference system of the system A, the second relative reference system of the system B and the absolute reference system O have the same orientation, with the respective vertical axis to the respective zenith and axis y oriented to the North, if the distance D between the systems A and B does not exceed 25 Km.

If the first relative reference system of the system A, the second relative reference system of the system B and the absolute reference system O has the same orientation with the respective vertical axis of the respective zenith and axis y oriented to the North, the Earth may be approximated to a plane, the zeniths of the relative reference systems of the systems A and B may be considered parallel, and North may be considered in common at low latitudes.

If, instead, the distance D between the systems A and B exceeds 25 Km, geocentric coordinates are then preferably used or the orientations of the relative reference systems are corrected by means of Euler angles.

According to the above description, the present invention allows a 3D track to be determined as fusion of two or more 2D or 3D tracks which come from different target location systems, relate to a same instant in time and which, if they satisfy the correlation test, are deemed to relate to a same real object.

The three-dimensional target tracking method according to the present invention finds advantageous, but not exclusive application in maritime, land and air surveillance.

In detail, in the scope of maritime surveillance, if the 20 target location systems used are dedicated to detecting only naval surface tracks, the three-dimensional tracking method according to the present invention allows possible air tracks to be ignored. Indeed, the correlation of the kinematics of a target with the calculation of the height allows ambiguity to be solved if aircrafts flying at low height, e.g. helicopters or airplanes, which appear on the horizon, interfere with the naval surface tracks.

Furthermore, in land surface, e.g. in airports, the three-dimensional tracking method according the present invention allows low height air tracks to be discriminated and located with greater accuracy during landing and take-off in the airport maneuvering areas.

Finally, in air surveillance, the three-dimensional tracking method according to the present invention allows aircraft air tracks to be discriminated and located with greater accuracy. For example, the present invention could be advantageously exploited to provide a portable air surveillance system which, by only using 2D targets, is capable of locating 3D air tracks with accuracy.

For the application of the present invention to maritime, land and air surveillance it is meaningful to discriminate between 3D tracks belonging to the land or air domain.

In this regards, FIG. 6 schematically shows:
a circle 16 which represent the Earth; and
a 2D target location system 17 which
   is positioned on the surface of the Earth 16, and is thus at a distance R_{T} from the centre of the Earth 16, where R_{T} represents the radius of the Earth 16,
   detects at a distance ρ a target 18 which is positioned at a distance, i.e. at a height, H from the surface of the Earth 16, and
   has a maximum linear measuring angle Err_{MAX}; and
a Φ_{target} angle which has vertex in the centre of the Earth 16, and which is subtended between the position of the 2D target location system 17 and the position of the target 18.

As shown in FIG. 6:

H=R_{T}secΦ_{target}−R_{T}

Reference is preferably made to the surface search domain if the size order of height H of target 18 is:

H=R_{T}secΦ_{target}−R_{T}≦Err_{MAX}.

Therefore, in maritime and land surveillance, given a first 2D track of a first 2D location system, the 2D tracks of a second location system 2D which may be correlated with said first 2D track may be conveniently sought about a first 2D track, because the position of the target seen by both 2D location systems falls within a limited correlation window which depends on the 2D location system error and on the history of the target. For example, primary coastal or naval radars may import the height calculation without needing to modify the criteria to search the tracks which may be correlated, which criteria are limited to the error windows about the first 2D track.

Furthermore, again preferably, reference is made to air search domain if the order of size of height H of the target 18 is:

H=R_{T}secΦ_{target}−R_{T}>Err_{MAX}

Therefore, in air surveillance, the search is carried out on all 2D tracks. Indeed, in air surveillance, upon arrival of a new 2D track by a 2D location system, which must be compared by means of correlation tests with all the 2D tracks acquired by the other 2D location systems.

The search criterion for the air domain includes the case of surface domain, which is thus a subset.

Therefore, the three-dimensional tracking method with search criteria on all 2D tracks works in any domain.

The advantages of the invention can be readily understood from the above description.

In particular, it is emphasized once again that the present invention allows a single three-dimensional track of a target present in said shared Coverage region to be determined on the basis of kinematic data produced by at least two 2D or 3D location systems having a shared coverage region.

Furthermore, the three-dimensional target tracking method according to the present invention is applicable to any number N of target location systems, with N>1, which may be all positioned on the ground, even at different heights, or may be all installed on respective moving means, or some of which may be installed on respective moving means and others may be positioned on the ground.

Finally, it is apparent that many changes can be made to the present invention all included within the scope of protection defined by the appended claims.

1. A three-dimensional target tracking method comprising:
acquiring a first track generated by a first target location system (2, 11, A) having a first coverage area (13), said first track comprising a first position of a first target at a given time in a first relative reference system of the first target location system (2, 11, A);
acquiring a second track generated by a second target location system (2, 12, B) having a second coverage area (14) partially overlapping the first coverage area (13) in a coverage region (15) shared by the two target location systems (2, 11, 12, A, B), said second track comprising a second position of a second target at the given time in a second relative reference system of the second target location system (2, 12, B);
carrying out a correlation test which includes
checking whether a same height (h_{O}) is determined for the first target and the second target in a given three-dimensional reference system on the basis of the first position and the second position, and
if a same height (h_{O}) is determined for the first target and the second target in the given three-dimensional reference system, detecting that the first target and the second target represent a same single target (T, P) present in the shared coverage region (15); and,
if the first target and the second target represent a same single target (T, P) present in the shared coverage region (15), generating a three-dimensional track which comprises a three-dimensional position of said same single target (T, P) at the given time in the given three-dimensional reference system, said three-dimensional position comprising the same height (h_{O}) determined for the first target and the second target in the given three-dimensional reference system.

2. A three-dimensional target tracking method according to claim 1, wherein the correlation test is carried out if a given distance (D) between the two target location systems (2, 11, 12, A, B) satisfies a given relation with a given maximum linear measuring error of the two target location systems (2, 11, 12, A, B).

3. A three-dimensional target tracking method according to claim 2, wherein the correlation test is carried out if the given distance (D) is higher than, or equal to, said maximum linear measuring error.

4. A three-dimensional target tracking method according to claim 3, wherein the given maximum linear measuring error equals the greater of a first maximum linear measuring error of the first target location system (2, 11, A) and a second maximum linear measuring error of the second target location system (2, 12, B).

5. A three-dimensional target tracking method according to claim 1, wherein at least the first acquired track is expressed in slant or bearing or spherical coordinates.

6. A three-dimensional target tracking method according to claim 5, wherein if the second acquired track is also expressed in slant or bearing or spherical coordinates, the correlation test includes:
determining a first direction identified on a reference plane (PO) of the given three-dimensional reference system by the first position and by a position of the first target location system;
determining a second direction identified on the reference plane (PO) of the given three-dimensional reference system by the second position and by a position of the second target location system;
checking whether the first direction and the second direction satisfy a first given condition;
if the first direction and the second direction satisfy the first given condition, checking whether the first position, the second position and a given distance (D) between the two target location systems (2, 11, 12, A, B) satisfy a triangle-inequality-related condition; and,
if the first position, the second position and the given distance (D) satisfy the triangle-inequality-related condition, checking whether a same height (h_{O}) is determined for the first target and the second target in the given three-dimensional reference system.

7. A three-dimensional target tracking method according to claim 6, wherein the first direction and the second direction satisfy the first given condition if they either intersect or coincide.

8. A three-dimensional target tracking method according to claim 6, wherein the first position, the second position and the given distance (D) satisfy the triangle-inequality-related condition if a sum of a first distance (ρ_{A}) of the first target from the first target location system (2, 11, A) in the first relative reference system and of a second distance (ρ_{B}) of the second target from the second target location system (2, 12, B) in the second relative reference system is higher than, or equal to, said given distance (D) decreased and increased by a given measuring error of the two target location systems (2, 11, 12, A, B).

9. A three-dimensional target tracking method according to claim 8, wherein the given measuring error of the two target location systems (2, 11, 12, A, B) is equal to a sum of a first range measuring error of the first target location system (2, 11, A) and of a second range measuring error of the second target location system (2, 12, B).

10. A three-dimensional target tracking method according to claim 5, wherein if the second acquired track is expressed in geographic or Cartesian coordinates, the correlation test includes:
determining a first direction identified on a reference plane (PO) of the given three-dimensional reference system by the first position and by a position of the first target location system;
determining a third position of the second target on the reference plane (PO) of the given three-dimensional reference system on the basis of the second position and of an origin position of the second relative reference system in the given three-dimensional reference system;
checking whether the first direction and the third position satisfy a second given condition; and,
if the first direction and the third position satisfy the second given condition, checking whether a same height (h_{O}) is determined for the first target and the second target in the given three-dimensional reference system.

11. A three-dimensional target tracking method according to claim 10, wherein the first direction and the third position satisfy the second given condition if said first direction passes through the third position.

12. A three-dimensional target tracking method according to claim 1, wherein the first acquired track also comprises a first speed of the first target at the given time in the first relative reference system;
wherein the second acquired track also comprises a second speed of the second target at the given time in the second relative reference system;
and wherein generating a three-dimensional track comprises calculating a three-dimensional speed of said same single target (T, P) at the given tine in the given three-dimensional reference system on the basis of the first position, the second position, the first speed, the second speed and the same height (h_{O}) determined for the first target and the second target in the given three-dimensional reference system, said three-dimensional track also comprising the calculated three-dimensional speed.

13. A three-dimensional target tracking method according to claim 12, wherein the three-dimensional speed is also calculated on the basis of:
a first quantity, which is related to the same height (h_{O}) determined for the first target and the second target in the given three-dimensional reference system and indicates a first height of the first target at the given time in the first relative reference system; and
a second quantity, which is related to the same height (h_{O}) determined for the first target and the second target in the given three-dimensional system and indicates a second height of the second target at the given time in the second relative reference system.

14. A processor (3) configured to implement the three-dimensional target tracking method claimed in claim 1.

15. A three-dimensional target tracking system (1) comprising:
a first target location system (2, 11, A) having a first coverage area (13) and configured to generate first target tracks;
at least a second target location system (2, 12, B) having a second coverage area (14) partially overlapping the first coverage area (13) and configured to generate second target tracks; and
the processor (3) claimed in claim 14, said processor (3) being coupled to the first target location system (2, 11, A) for acquiring the first target tracks generated by said first target location system (2, 11, A), and to the second target location system (2, 12, B) for acquiring the second target tracks generated by said second target location system (2, 12, B).

16. A three-dimensional target tracking system (1) according to claim 15, wherein each of the target location systems (2, 11, 12, A, B) is a radar system or a radio direction finding system or a satellite location terminal.

17. A software program product comprising software code portions loadable in a memory of a processor (3), executable by said processor (3) and such that to cause, when executed, said processor (3) to become configured to implement the three-dimensional target tracking method claimed in claim 1.
